(19) United States
(12) Patent Application Publication
(10) Pub. No.: US 2025/0292337 A1
(43) Pub. Date: Sep. 18, 2025

(54) COMPUTER IMPLEMENTED SYSTEM AND METHOD FOR VIRTUALLY CONNECTING LIKE-MINDED INDIVIDUALS

(71) Applicants: Kate Nuttall, Victoria (AU); Jonathan Green, Victoria (AU)

(72) Inventors: Kate Nuttall, Victoria (AU); Jonathan Green, Victoria (AU)

(21) Appl. No.: 18/861,067

(22) PCT Filed: Apr. 28, 2023
(86) PCT No.: PCT/AU2023/050353

§ 371 Date: Oct. 28, 2024

(30) Foreign Application Priority Data
Apr. 29, 2022 (AU) 2022901139

(51) Int. Cl. G06Q 50/00; G06F 21/60

(52) U.S. Cl. CPC G06Q 50/01; G06F 21/606

(57) ABSTRACT

A system and method for virtually connecting individuals seeking to make more meaningful connections with other individuals based upon the use of more accurate and comprehensive user profile information. The system and method is particularly useful for virtually connecting individuals based upon their likes, dislikes and other social media profile activity, wherein connections are established in a safe manner using encrypted communication

### FIELD OF THE INVENTION

The present invention relates to a system and method for virtually connecting individuals seeking to make more meaningful connections with other individuals based upon the use of more accurate and comprehensive user profile information. The system and method is particularly useful for virtually connecting individuals based upon their likes, dislikes and other social media profile activity, wherein connections are established in a safe manner using encrypted communication.

### BACKGROUND OF THE INVENTION

Due to advances associated with the internet, wireless communication, computers and smart devices that enable the creation of online social environments and communication platforms, the social landscape has experienced rapid changes in recent years, particularly in relation to how individuals interact and connect with one another.

The observed increase in popularity associated with online social environments is primarily attributable to the convenience associated with the use of computers and/or smartphones, since such devices enable online users to connect with one another at any time of the day whilst remaining within their own environment. For example, there are a number of online dating platforms that enable registered individuals to virtually connect with other registered users from the comfort of their own home, without the requirement to attend a social gathering or meeting at a public location.

Although online dating and similar platforms provide individuals with a convenient means for meeting other individuals in a virtual social setting, such interactions are usually based upon limited information regarding the individual. In addition, verification of a person's identity is often difficult, which can result in individuals being placed at risk when virtually connecting and/or meeting with other individuals in person.

In the example of online dating, user profiles are often generated based solely according to information obtained from answers entered by users in response to a variety of pre-defined questions and topics. Therefore, many profiles may be inaccurate or not sufficiently comprehensive due to the limited nature of the information associated with user responses, particularly responses to pre-selected questions/topics that are absent of any context.

Another problem associated with existing online social platforms is due to the limited nature of the information entered by users with respect to likes, dislikes, hobbies and other preferences in response to pre-defined and generic questions. In particular, users often virtually connect (either through self-selection or automatic matching) with other users who are either not like-minded, not available to socialise at a particular time and/or location or otherwise not well-matched, thereby resulting in wasted time and also wasted computing resources (eg. processing, memory and networking) arising from inefficient searching using such computing resources.

Accordingly, there exists a need for a system and method operable to generate more comprehensive and accurate user profiles that enable on-line users to be better-matched with like-minded individuals. There is also a need to reduce consumption of computing resources due to inefficient searching for appropriate matches between like-minded individuals and to prevent users from being matched and virtually connected (consuming additional computing resources) with poorly matched individuals and/or individuals who are unavailable to socialise in accordance with preferences of users (eg. a preferred day/time).

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for virtually connecting individuals, the method including, receiving, by one or more processors, information associated with each user of a plurality of users, the information including one or more of, an activity or activities of interest to the user, a location associated with the user, and a date and time regarding the user's availability to share an activity of interest with one or more other users, generating, by one or more processors, a user profile for each user in which the information associated with the user is recorded, verifying, by the one or more processors and using one or more verification techniques, the identity of each user and updating security details associated with the user profile of the user based upon a verification result, and comparing, by the one or more processors and using one or more artificial intelligence techniques, the information associated with each verified user to determine a similarity score for each user pair, the similarity score based upon an extent to which the information associated with the users in each user pair is determined as similar, determining, by one or more processors, whether the similarity score for each user pair exceeds a pre-defined threshold similarity score thereby indicating a match between verified users, receiving, by one or more processors, a request from a first user to establish a private and secure communication channel with one or more other users who are matched with the first user, and based upon the similarity score associated with the comparison between the first user and one or more other verified users exceeding the pre-defined threshold similarity score, providing, by one or more processors, the first user with a means of establishing a private and secure communication channel with the matching one or more other users.

In an embodiment, the method further includes, receiving, by one or more processors and from a device associated with the user, an instruction from the user to enable the one or more processors to establish a link or communication channel with the user device, including to interface with social media account(s) associated with the user and/or Global Positioning System (GPS) location tracking hardware and/or software operating on the user device.

In an embodiment, the location tracking hardware or software is operable to record GPS location data associated with the user.

In an embodiment, the method further includes collating, by one or more processors, the GPS location data based on the user's movements to thereby create a detailed profile of each user's movements and habits.

In an embodiment, the method further includes, predicting, by one or more processors, the activity or activities of interest to the user based on one or more of, social media activity or history extracted from the user's social media account(s), and the GPS location data associated with the user.

In an embodiment, the method further includes, storing, by one or more processors, user profiles in an indexed database that implements a data structure, and updating, by one or more processors, the indexed database based upon newly predicted activity or activities of interest to the user.

Accordingly, in this embodiment, the information associated with each user profile includes information automatically obtained by the system through monitoring the user's social media history/activity and GPS location data and predicting various interests associated with the user based on the GPS location data and/or social media data. For example, if the system automatically detects, by monitoring GPS location data associated with the user, that the user attends a cinema on a regular or semi-regular basis, the system may predict that the user enjoys attending the cinema and may include this in the user's profile.

Skilled persons will appreciate that the ability of the system to receive information regarding a user's availability to attend and share an activity of interest will reduce wastage of computing (processing, memory and networking) resources that would otherwise be consumed if such data were not collected and recorded by the system to afford efficient searching. In this regard, the ability of the system to collect and store availability data (i.e., date and time) regarding a user's availability to share an activity of interest with one or more other users avoids unnecessary communication over the network with other users that are not available to share an activity at the date and time indicated by the user.

Skilled persons will also appreciate that the ability of the system and method of the present invention to automatically predict, based at least upon a user's GPS location data and/or their social media history/activity, various interests/hobbies/activities associated with the user, the system is operable to generate a more comprehensive user profile with respect to each user, thereby increasing the likelihood that like-minded individuals will be more accurately located and matched according to searches conducted by users or suggested matches identified by the system. This will reduce wastage of computing resources (eg. processing, memory and networking resources) that would otherwise be consumed when sub-optimal (inaccurate) searching for, and identifying, matches are determined based upon profiles generated solely according to user responses entered by users in response to pre-defined generic questions.

In an embodiment, the method further includes, providing the user with a prompt to accept or reject predicted activities of interest to the user that are proposed for inclusion in the user profile of the user.

In an embodiment, the activity or activities of interest to the user include one or more of, attending the gym, walking, attending a café or bar or restaurant, attending the cinema, walking a dog, studying a course, and attending an event or concert.

In an embodiment, the information associated with each user is received as a result of prompting each user to enter details including in relation to the user's activities of interest, the location of the user, and date and time regarding the user's availability to share an activity of interest with one or more other users.

In an embodiment, verifying the identity of each user includes, establishing, by one or more processors, a communication link with one or more processors associated with one or more external databases to obtain information to verify the identity of the user.

In an embodiment, the one or more external databases include, a Passport Office, a Births, Deaths and Marriages Registry, a Department of Justice and/or Community Safety Registry, a Public Record Office.

In an embodiment, verifying the identity of each user includes performing one or more of a security and a police check.

For example, the system may establish a communication link with a Passport Office, one or more official registries (for example, a Registries of Births, Deaths and Marriages), the Department of Justice and Community Safety (eg. to establish Working with Children Checks), or various Public Record Offices maintaining information with respect to criminal records.

In an embodiment, data exchanged between the user devices and the one or more processors is encrypted using Security Assertion Markup Language (SAML), wherein a software application operating on each user device employs code obfuscation software to protect downloaded data in a multi-layered Trusted Execution Environment (TEE), and the accuracy of information is verified using a Security Sockets Layer (SSL) encrypted cloud service central administration tool.

In an embodiment, providing the first user with a means of establishing a private and secure communication channel with the matching one or more other users includes, providing the first user with a selectable link (eg. a URL) to establish the private and secure communication channel.

In an embodiment, selection of the link enables a live chat between the first user and the matched other user, wherein communications via the live chat is private and protected using a data masking Host-based Intrusion Detection System (HIDS).

In an embodiment, providing the first user with a means of establishing a private and secure communication channel with the matching one or more other users includes, providing, by one or more processors, the first user with a search facility to search for matching one or more other users including based on keyword(s) entered by the first user, wherein keyword(s) entered are analysed using one or more artificial intelligence techniques.

In an embodiment, the search facility further provides the first user with the ability to filter search results, including based on one or more of, an activity or activities of interest of the matching one or more other users, a location of the matching one or more other users, a date and time regarding the availability of matching one or more other users to share an activity of interest. Skilled persons will appreciate that the ability to refine a search to a particular date and time will also reduce the number search results returned as a match by the system, further avoiding wastage of computing resources that would otherwise occur.

In an embodiment, the method further includes, generating, by one or more processors, notifications to matching one or more other users based on, the matching one or more other users being matched and/or selected by the first user for establishing a private and secure communication channel, the matching one or more other users being in a geographical location proximal to the first user's location, and the matching one or more other users being available to socialise.

In another aspect, the present invention provides a computer-implemented system for virtually connecting individuals, the system including one or more processors configured to, receive information associated with each user of a plurality of users, the information including one or more of, an activity or activities of interest to the user, a location associated with the user, and a date and time regarding the user's availability to share an activity of interest with one or more other users, generate a user profile for each user in which the information associated with the user is recorded, verify, using one or more verification techniques, the identity of each user and updating security details associated with the user profile of the user based upon a verification result, and compare, using one or more artificial intelligence techniques, the information associated with each verified user to determine a similarity score for each user pair, the similarity score based upon an extent to which the information associated with the users in each user pair is determined as similar, determine whether the similarity score for each user pair exceeds a pre-defined threshold similarity score thereby indicating a match between verified users, receive a request from a first user to establish a private and secure communication channel with one or more other users who are matched with the first user; and based upon the similarity score associated with the comparison between the first user and one or more other verified users exceeding the pre-defined threshold similarity score, provide the first user with a means of establishing a private and secure communication channel with the matching one or more other users.

In yet another aspect, the present invention provides a computer-readable medium including computer instruction code that when executed on a computer, causes one or more processors of the computer to perform the steps of receiving information associated with each user of a plurality of users, the information including one or more of, an activity or activities of interest to the user, a location associated with the user, or a date and time regarding the user's availability to share an activity of interest with one or more other users, generating a user profile for each user in which the information associated with the user is recorded, verifying, using one or more verification techniques, the identity of each user and updating security details associated with the user profile of the user based upon a verification result, and comparing, using one or more artificial intelligence techniques, the information associated with each verified user to determine a similarity score for each user pair, the similarity score based upon an extent to which the information associated with the users in each user pair is determined as similar, determining whether the similarity score for each user pair exceeds a pre-defined threshold similarity score thereby indicating a match between verified users, receiving a request from a first user to establish a private and secure communication channel with one or more other users who are matched with the first user, and based upon the similarity score associated with the comparison between the first user and one or more other verified users exceeding the pre-defined threshold similarity score, providing the first user with a means of establishing a private and secure communication channel with the matching one or more other users.

In a still further aspect, the present invention provides a portable electronic device for use by a first user seeking to virtually connect with other individuals, the device including, a touch screen configured to receive an input corresponding to a touch operation of the first user on an area of the touch screen, and a processor operably connected with the touch screen, wherein the processor is configured to detect the input to the touch screen and perform operations including, receiving information associated with each user of a plurality of users including the first user, the information including one or more of, an activity or activities of interest to the user, a location associated with the user, or a date and time regarding the user's availability to share an activity of interest with one or more other users, generating a user profile for each user in which the information associated with the user is recorded, verifying, using one or more verification techniques, the identity of each user and updating security details associated with the user profile of the user based upon a verification result, comparing, using one or more artificial intelligence techniques, the information associated with each verified user to determine a similarity score for each user pair, the similarity score based upon an extent to which the information associated with the users in each user pair is determined as similar, determining whether the similarity score for each user pair exceeds a pre-defined threshold similarity score thereby indicating a match between verified users, detecting, via the touch screen, a first input from a user requesting the establishment of a private and secure communication channel with one or more other users who are matched with the first user, based upon the similarity score associated with the comparison between the first user and one or more other verified users exceeding the pre-defined threshold similarity score, providing the first user with a means of establishing a private and secure communication channel with the matching one or more other users using the touch screen.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various systems and components;

FIG. 2 illustrates a diagram associated with an example server component within the system illustrated in FIG. 1;

FIG. 3 illustrates an exemplary flow diagram of a process that enables a user to download and install a software application, and subsequently access, or register to use, the software application for interaction with the system illustrated in FIG. 1, including a search request interface and identity verification interface;

FIG. 4 illustrates an exemplary flow diagram of a process that enables a group of users to establish a private and secure communication channel regarding an activity of interest after being matched, including use of an indexed database that receives and records information associated with each user, and an alerts/notifications interface; and

FIG. 5 illustrates a diagram associated with additional example interfaces of the software application including a social media interface and a payment interface.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

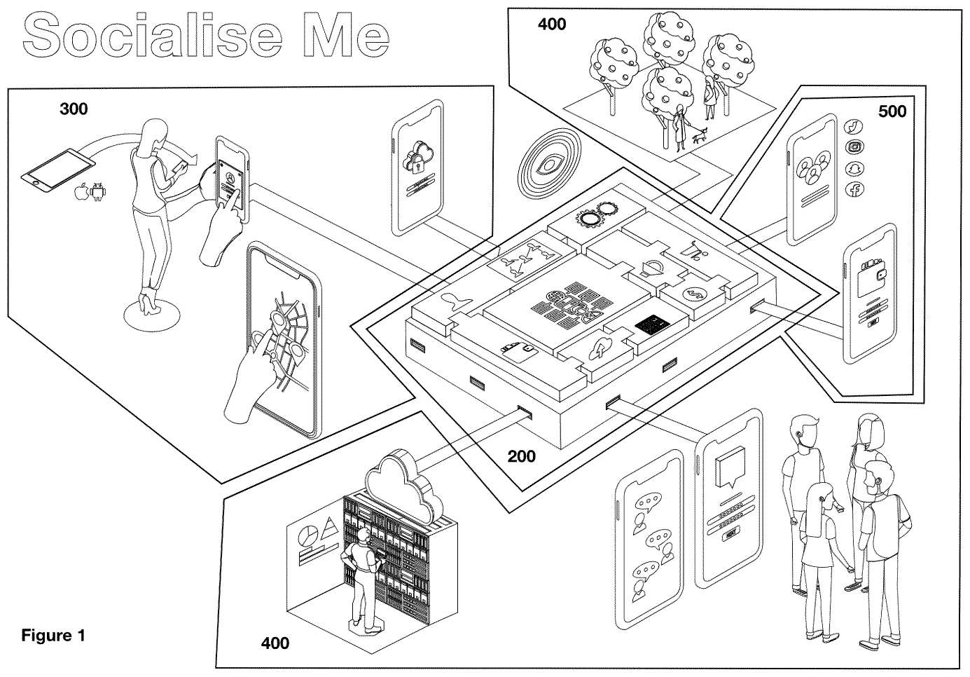

The present invention, according to an embodiment, relates to a system and method for virtually connecting individuals (30) sharing a common interest or activity, as depicted in FIG. 1. The system and method provide a platform that hosts a computer-executable software application (40), wherein the application (40) is accessible by the plurality of individuals (also referred to herein as users) (30). The platform enables the establishment of a private and secure communication channel between two or more matched and verified users (30) thereby enabling secure communication between the matched and verified users (30). Users are considered matched when one or more of the location of the user, an activity of interest specified by the user, or a date and time regarding the user's availability to share the activity of interest with one or more other users, matches corresponding information associated with other registered users according to a pre-defined threshold similarity.

The platform is provided by a central server (20) which maintains one or more processors and/or databases for performing functions, including receiving the abovementioned information from each user (30), recording the information associated with each user (30) in a database (e.g. indexed database (60)), and then utilizing the database (60) to compare, by the use of one or more artificial intelligence techniques, the information associated with verified users. A similarity score between different users is subsequently determined, along with a further determination regarding whether the similarity score exceeds a pre-defined threshold similarity score thereby indicating a match between two or more verified users. The server (20) is further configured to establish a private and secure communication channel between matched users. Further, the identity of each user is verified and their profiles securely maintained.

The received information relating to each user (30) may be verified such that the authenticity of information presented by each user (30) is verified against public and/or private third party records and information. The server (20) may subsequently receive requests from a particular user (30) to search for other users who match with the particular user (30) according to the pre-defined threshold similarity score, and based upon processing the request along with the information stored in database (60), additional matching users may be efficiently located and the private and secure communication between the matching users established.

Accordingly, out of the hundreds, thousands or more users (30) who are registered to utilize the software application (40), only a subset of those users (30) will be selected as an appropriate match with a user (30) conducting a search based upon a comparison of their information indicating that a minimum similarity threshold has been satisfied, i.e. similarities between specified activities of interest, locations associated with each user, and/or dates and times regarding the users' availability to share the activity of interest.

The person skilled in the relevant field of technology will appreciate that the platform provides a solution to existing problems associated with virtually connecting individuals seeking to make meaningful connections with other users, including the lack of accuracy with respect to matching individuals, the lack of verification of user identities, and the general lack of collection of accurate and comprehensive user information which is important when seeking to establish more comprehensive user profiles for the purpose of matching individuals seeking to achieve meaningful connections. The person skilled in the relevant field of technology will further appreciate the conservation of computer processing, memory and networking resources arising from the more efficient and accurate searching for and matching of individuals, and subsequent establishment of a private and secure communication channel between such individuals through use of a single platform.

In view of the above practical and useful results that arise from implementation of the described embodiment of the present invention, the use of a data communications device (50) upon which the software application (40) is operated, as well as the indexed database (60) which enables the more efficient location and determination of matching individuals (30), represents an advance as compared with conventional or previously known systems or techniques utilized for virtually connecting individuals.

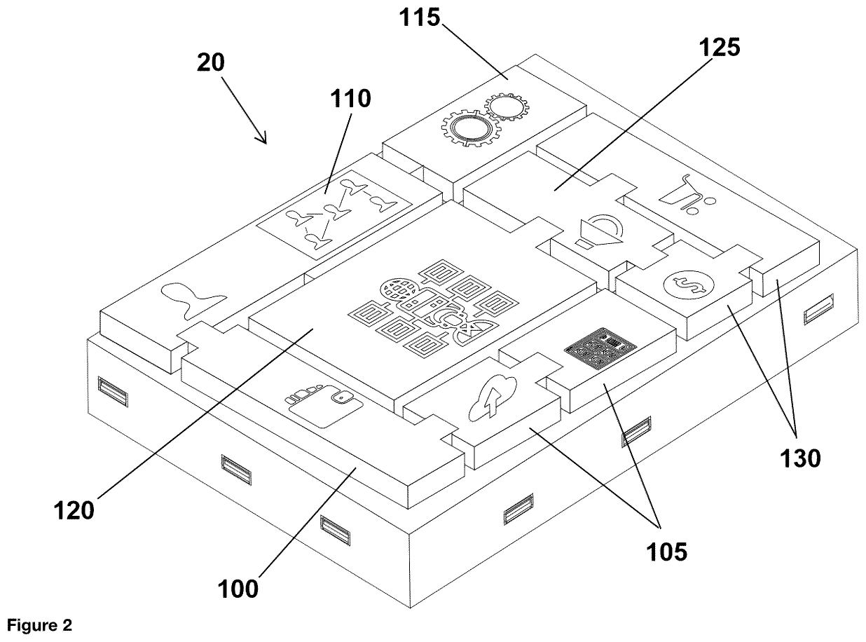

FIG. 1 is divided into segments which are further expanded in subsequent FIGS. 2 to 5. In particular, Segment 200 of FIG. 1 shows the server component (20) with which a software application (40) operating on data communication devices (50) of individual users (30) are configured to communicate. It will be apparent to eh person skilled in the relevant filed of technology that the software application (40) may be a mobile application or a web application, and similarly, the device (50) utilised by each user (30) may be a portable device such as a mobile phone, tablet or laptop, or alternatively a fixed location device such as a personal computer. The server component (20) is additionally detailed in FIG. 2.

The skilled person will appreciate that the steps described herein may be executed by the device (50) wherein such operations are facilitated by the software application (40) operating on each device. According to another implementation of the present invention, the server (20) is programmed to provide most or all of the functions described herein particularly where they cannot be provided locally on the user devices (50) or where it may be impractical to do so. In other words, the steps described herein as performed by the device (50), or components thereof, may be associated with hardware that is located externally of the device, such as the remote central server (20) for example (i.e. in a distributed architecture). Different arrangements are possible in this regard, and alternate variations will be apparent to the person skilled in the relevant field of technology.

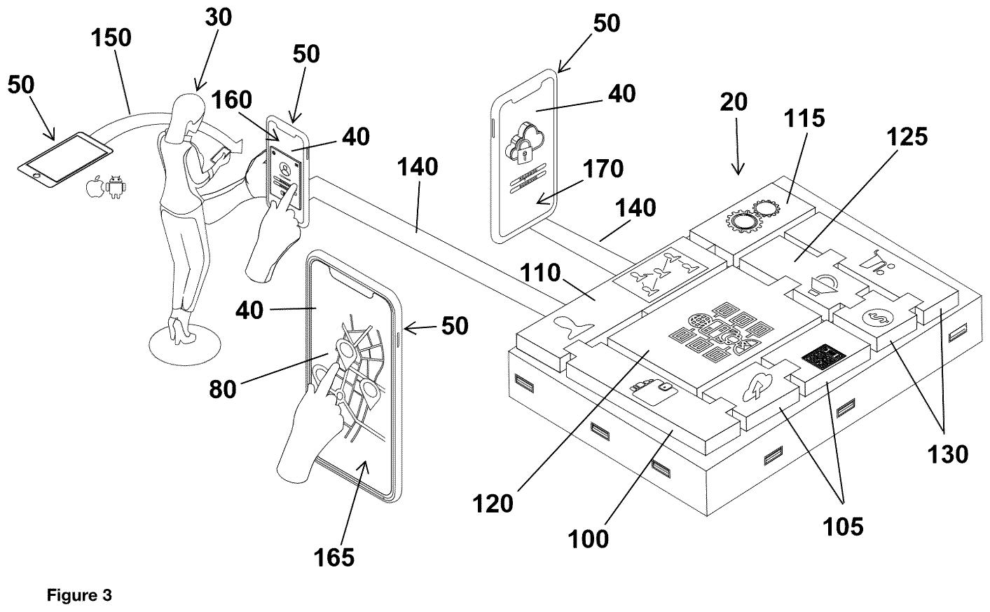

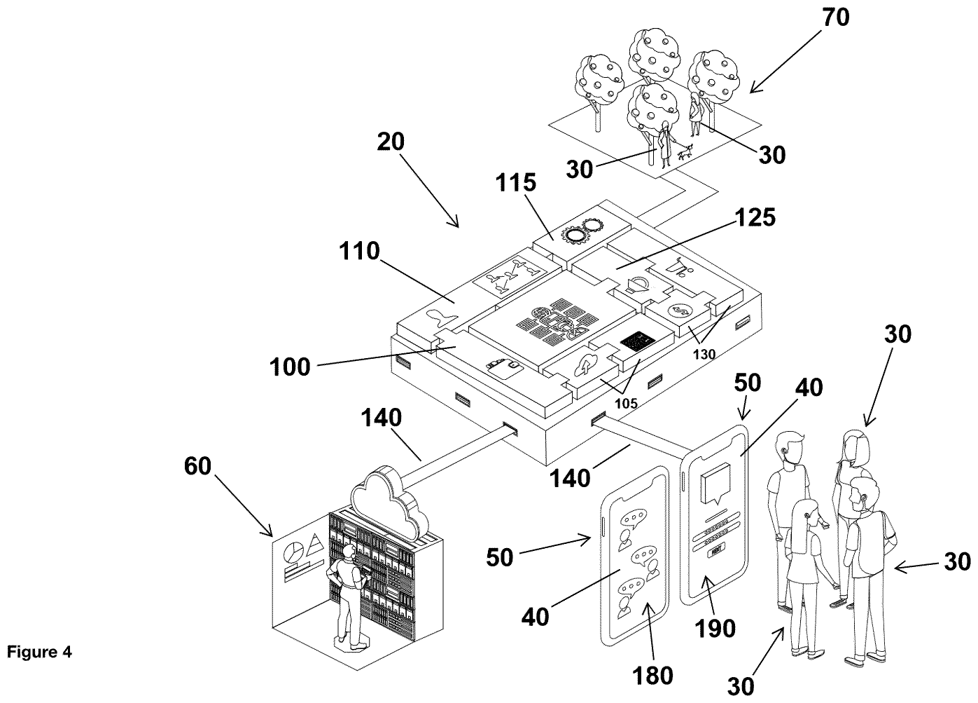

Segment 300 of FIG. 1 shows how the server (20) may be configured for communication with the devices (50) associated with users (30). In one example, the server (20) may receive data from a device (50) for the purpose of creating a user profile, e.g. based upon the information received from an individual (30). The server (20) may then verify such details, as further detailed in FIG. 3. Segment 300 of FIG. 1 further shows a user (30) downloading and installing the application (40) and subsequently accessing the application (40) to establish an account and profile and to commence searching for other users with whom the user (30) may be able to make a meaningful connection. Segment 400 of FIG. 1 shows an example activity of interest (70) (i.e. walking a dog), an indexed database (60) which may be accessed and utilized for the purpose of comparing information associated with different verified users to determine the similarity score associated with the particular comparison. Segment 400 also illustrates example interface (180) in which secure communication between matched verified users is enabled and example interface (190) where alerts and/or notifications may be received, as further detailed in FIG. 4. Segment 500 of FIG. 1 shows additional example interfaces in which additional functionality associated with the software application (40) may be accessed by each user (30), including a social media interface (205) and a payment interface (210).

As mentioned above, FIG. 2 shows in greater detail Segment 200 of FIG. 1, and in particular, FIG. 2 shows the server component (20) which includes infrastructure upon which the platform of the present invention operates. The infrastructure may be local or cloud-based. The central server (20) may operate one or more computer processors and maintain one or more databases to enable the following functionality and/or storage:
User account register (100) storing details of each individual (30) including information relating to an activity of interest (70), a location (80) associated with the user (30), and/or a date and time regarding the user's availability to share the activity of interest (70) with one or more other users. Additional details which may be stored in user account register (100) include name, address, contact details, and any additional detail which may be relevant for the purpose of identifying each user (30). Further details which may be stored in the user account register (100) include details relating to general interests of each user, a personality of each user, and other general characteristics, which may be requested of each user to facilitate the matching of users with other users;
User profile register (105) and associated functionality for storing profile data and generating profiles relating to each of the individuals (30) including uploaded photos and video, and any additional details from register (100) which the user (30) confirms they prefer to make visible on their user profile including information relating to their hobbies, interests and activities;
Social media and location database (110) storing details relating to social media accounts and recorded locations (80) associated with individuals (30), including links to social media accounts associated with individual users (30) as well as current and historical location data associated with users (30);
Verification functionality (115) for verifying information submitted by individuals (30) including their identification information. For example, verification functionality (130) may authenticate that the individual (30) is rightly who he/she claims, including by performing identification checks. Additional checks may be required for the purpose of confirming that the individual (30) is of sufficient character to be considered a safe person to meet with (e.g. police checks, etc.), and for the purpose of confirming that the details presented by the user (30) match details that may be accessible from one or more other databases (e.g. public and/or private databases);
Data processing functionality (120) for comparing, using one or more artificial intelligence techniques, information associated with verified users and determining whether similarity scores associated with the comparison of individuals exceeds a pre-defined threshold similarity score (thereby indicating a match between two or more verified users (30)). By indexing the information received from users (30) in a database (60), which may include a data structure, access to such information and location of one or more matching individuals based upon receiving a search request from user (30) is achievable in a more accurate and efficient manner;
Alerts/notifications functionality (125) for enabling the generation of alerts and/or notifications for a variety of reasons, as described further below, and which may be presented to individuals through interface (190) of the software application (40) or by other means (e.g. text message, email or push notification);
Payment gateway (130) which enables any financial transactions to be implemented using the software application (40) including, for example, in relation to the payment of a subscription fee to utilize the software application, or to access the full functionality of the software application (40) which may otherwise not be available to non-subscribing users.

FIG. 2 also depicts that server (20) is configured to enable communication (140) with the devices (50) and, in particular, the software application (40) operating on each device (50). Such communication may occur via the internet or other data communications network.

FIG. 3 shows in greater detail Segment 300 of FIG. 1 and, in particular, the steps associated with a user (30) installing (150) the software application (40) on their device (50), and subsequently accessing a user login and registration interface (160) associated with the application (40). Such access may be granted after the user (30) has installed the application (40), which may be achieved by downloading the application (40) from an application store, and has been verified. Each user (30) may create an account (which may include a user profile) using the application (40) and the account/profile information may be stored in the user account and profile registers (100) and (105), respectively.

Once each user (30) has accessed the application (40), the user (30) may be presented with a further interface that allows the user (30) to create and maintain a user profile that will be visible to other users utilizing the software application (30) to conduct searches for other matching users, and thereby enable the other users to view information about the user (30). For example, the user profiles which are stored in register (105) may contain basic information about each user (30) including name, age, location (80), hobbies, interests, and activities, along with associates photos, videos, etc, and over time, the user profiles may include additional information such as historical data relating to events attended, other users with whom the user (30) has connected, etc.

To assist with the development of the user profiles, the system may be further configured to receive an instruction from the user (30) to link with one or more of their social media accounts and/or GPS location data (details of which may be stored in database (110)) in order to receive additional data and thereby develop a more robust profile. For example, the system may be configured to access GPS location data from a device (50) of the user and/or social media history/activity data processed and/or maintained by the user devices (50), and such information may be utilized to predict various interests associated with the user (30). In this way, it will be appreciated that the interests of the user (30) need not necessarily be manually entered by the user (30) but may be automatically generated and included in the user profile based upon other information that has been entered or retrieved. In another embodiment, the interests of the user may be determined based on a combination of manually entered and automatically generated information.

Similarly, by monitoring GPS location data associated with the user (30) additional predictions regarding interests of the user may be generated. For example, where the user attends a cinema on a regular, or semi-regular, basis, the system may predict that the user (30) enjoys attending the cinema and such information may be automatically uploaded to the user's profile. The system may provide each user (30) with an opportunity to either accept or reject a predicted interest automatically generated by the system for inclusion in the user profile, and in this regard, the system may learn over time what is likely to be an accurate predicted interest. Accordingly, the automatic generation of predicted interests will improve and a machine learning model may be trained and utilised in this regard.

Another example of an interest of a user automatically detected is where the user's social media history/activity is analyzed (e.g. using one or more natural language techniques) and where the system detects that the work of a particular artist (e.g performer) is liked or appreciated by the user (30). The user profile may be automatically updated to include the artists in their user profile.

Accordingly, it will be appreciated that by monitoring the user's location data (e.g. by GPS technology) which may include tracking the location of the user's device (50), and/or monitoring the user's social media activity, more comprehensive information about the user (30) may be obtained and hence a more detailed profile may be developed for each user. Such profiles may then be utilized for the purpose of more accurately and efficiently matching users. FIG. 3 shows an example interface (165) in the form of an interactive map in which the user (30) is automatically matched with other registered users (30) based upon those users being within a predetermined vicinity of the user location (80) and where those users have been matched with user (30) according to the similarities between them satisfying a threshold.

However, as described earlier the matching of users need not occur automatically and an interface (not shown) may be presented to the user (30) to enable the user to manually search for other users based upon a specific search request submitted by the user (30). For example, users (30) may search for potential matches by keyword, wherein matching with one or more other users is performed using one or more artificial intelligence techniques to analyze the key words entered by users (30). Indeed, users (30) may search for other matching users based upon the entry of keywords relating to any one or more profile fields including, for example, the activity or activities of interest specified by the user, the date and time regarding the user's availability, etc. For example, conducting a search for other like-minded individuals on the basis of a pre-selected date and time regarding the user's availability to share an activity of interest may be particularly useful for users who are time restricted. Skilled persons will appreciate that the ability to refine a search in this way, e.g. to a particular date and time for sharing an activity of interest, will significantly reduce the number of search results returned as a match by the system, further avoiding wastage of computing resources that would otherwise occur.

FIG. 3 also shows an interface (170) representing an example interface for verifying data submitted by each user (30). In this regard, all details relating to users (30) may undergo a verification process including comparison of details submitted with publicly or privately accessible data associated with the users (30) including any databases managed by third parties. For example, the server (20) may be configured to interface with such databases using an application programming interface (API) or similar.

According to an example, the submitted details may be compared with data stored in one or more Government databases such as a police records database. It is important for persons engaging in meeting with potential strangers to be sufficiently stable such that they do not pose a danger to others, and consulting police records or similar historical records associated with any one user (30) may be useful in confirming same. Depending upon the result of such interrogation, the ability of users (30) to access the software application (40) may be prevented or reduced.

Additional examples of external databases which may be interrogated for the purpose of verification include a passport office, official registries such as the registry of births, deaths and marriages, the department of justice and community safety, etc.

Additional security measures may also be taken with respect to the utilization of particular hardware and/or software. For example, all information exchanged using the software application (40) may be encrypted using a Security Assertion Markup Language (SAML), and the application (40) may employ code obfuscation software to protect downloaded data in a multi-layered Trusted Execution Environment (TEE). The system application may further verify the accuracy of the information via Security Sockets Layer (SSL) encrypted cloud service central administration tool.

FIG. 4 shows in greater detail Segment 400 of FIG. 1 and, in particular, an example activity (70) of interest associated with user (30), namely, walking a dog in the park. This activity involves two matching and verified users (30) arranging to meet at a park to walk their dogs together, where the encounter was initiated using the software application (40) after the two users were successfully matched. FIG. 4 also shows a group of four additional users (30) communicating with one another from remote locations utilizing the software application (40) via an interface (180) which provides a private and secure communication channel between the four users (30). In this regard, when search results are presented to users (30) or where the users (30) are automatically matched with one or more other users, they may also be provided with a selectable link (e.g. a URL) to establish a private and secure communication channel as shown in interface (180). In this way, selection of the link enables a live chat function between matched users hosted by the system, and communication via the chat function is private and protected (e.g. by a unique data-masking Host-based Intrusion Detection System (HIDS)). Once engaged in private and secure chat, the users (30) may make arrangements to engage in their activity of interest (70) together.

The ability of the platform to collect and store information associated with users (30) in an indexed database (60) (e.g using a data structure), including information relating to one or more of an activity of interest (70) to the user (30), a location (80) of the user (30), and a date and time regarding the user's availability, etc., results in a much more accurate and efficient mechanism for virtually connecting like-minded individuals by way of retrieval and subsequent comparison of such information achieving a pre-defined threshold similarity score, thereby also avoiding unnecessary communication over a network and generally reducing wastage of computing resources that would otherwise occur with existing systems.

In addition, by automatically predicting (e.g. based upon the user's GPS location data and/or their social media history/activity) various interests/hobbies/activities associated with the user (30), a more comprehensive user profile may be established with respect to the user (30), thereby increasing the likelihood that like-minded individuals will be more accurately located and matched according to searches conducted by the user (30) or via suggested matches identified by the system.

FIG. 4 also shows an example alert/notification interface (190) which may be presented to users (30) when the user (30) is to be alerted or notified for any reason including, for example where a matching user has been detected. In another example, a user (30) may receive an alert when another matched user is detected at a geographical location (80) that is within a predetermined geographical vicinity of the user (30).

It will also be understood that at any point where a user (30) becomes aware of another user, matched or otherwise, whilst using the software application (40), the user (30) may select the other user in order to view their profile, wherein the user (30) is also provided with an option to connect with the other user (irrespective of whether the application (40) has indicated a match with that user).

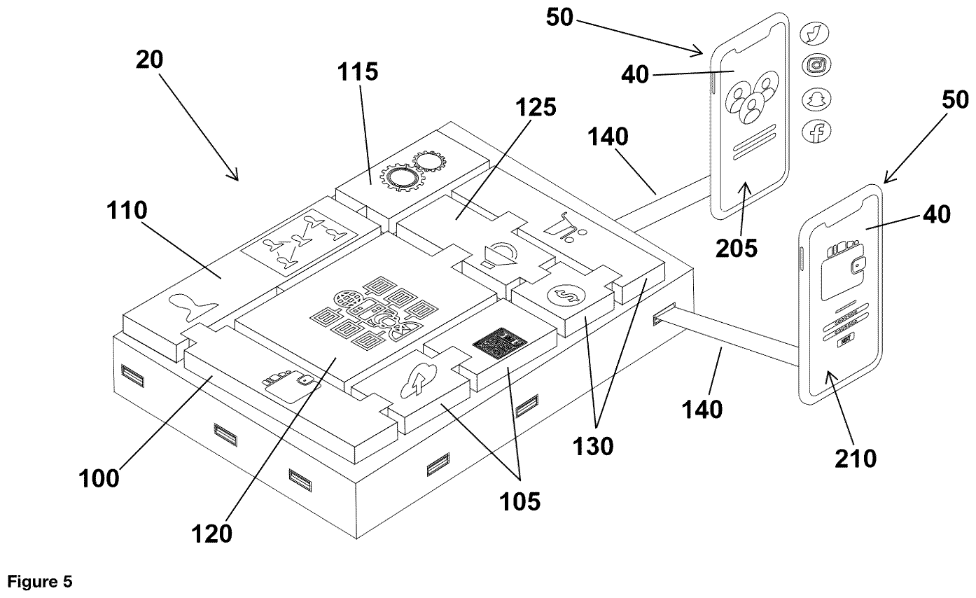

FIG. 5 shows in greater detail Segment 500 of FIG. 1 and, in particular, an example interface (205) associated with software application (40) for enabling users (30) to enter information relating to their various social media accounts including, for example, Twitter, Instagram, Pinterest and/or Facebook. Such data and/or links may subsequently be stored in the social media database (110) and utilized, as described above, for the purpose of determining interests and hobbies associated with users (30) with a view to establishing more comprehensive profiles for the users (30).

FIG. 5 also shows an example interface (210) associated with software application (40) for providing payment gateway functionality (130) to users (30). Financial transactions may be required from time to time for any number of reasons, including for example to enable users (30) to pay a subscription fee to a platform administrator utilizing the software application (40). In this regard, the user (30) may be requested to enter their bank account details and the server (20) may be configured to automatically interface with a relevant financial institution associated with the user (30) for the purpose of causing a monetary exchange to occur. An additional example of where such transactions may be required is where retailers located at particular locations of interest (70) advertise their goods and/or services via the application (40) and users (30) prefer to purchase same using the software application (40).

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for virtually connecting individuals, the method comprising:
in a user matching step:
receiving, by one or more processors, information associated with each user of a plurality of users, the information sourced from at least one social media account associated with the user and comprising:
an activity or activities of interest to the user;
a location associated with the user; and
a date and time regarding the user's availability to share an activity of interest with one or more other users;
generating, by one or more processors, a user profile for each user in which the information associated with the user is recorded;
verifying, by the one or more processors and using one or more verification techniques, the identity of each user and updating security details associated with the user profile of the user based upon a verification result; and
comparing, by the one or more processors and using one or more artificial intelligence techniques, the information associated with each verified user to determine a similarity score for each user pair, the similarity score based upon an extent to which the information associated with the users in each user pair is determined as similar;
determining, by one or more processors, whether the similarity score for each user pair exceeds a pre-defined threshold similarity score thereby indicating a match between verified users; and
in a user communication step that follows the user matching step:
based upon one or more other users determined in the user matching step to be matching with the first user such that the first user and each of the one or more other users forms a matching user pair, providing, by one or more processors, the first user with a means of establishing a private and secure communication channel with the one or more other users; and
receiving, by one or more processors, a request from a first user to establish a private and secure communication channel with one or more of the other users, and providing, in response to the request, a communication channel configured to enable the matching users to arrange to participate in one or more of the activities of interest.

2. The method of claim 1, further comprising:
receiving, by one or more processors from a device associated with the user, an instruction from the user to enable the one or more processors to establish a link or communication channel with the user device, comprising to interface with the social media account(s) associated with the user and/or Global Positioning System (GPS) location tracking hardware and/or software operating on the user device.

3. The method of claim 2, wherein the location tracking hardware or software is operable to record GPS location data associated with the user.

4. The method of claim 3, further comprising:
collating, by one or more processors, the GPS location data based on the user's movements to thereby create a detailed profile of each user's movements and habits.

5. The method of claim 3, further comprising:
predicting, by one or more processors, the activity or activities of interest to the user based on one or more of:
social media activity or history extracted from the user's social media account(s), and
the GPS location data associated with the user.

6. The method of claim 5, further comprising:
storing, by one or more processors, user profiles in an indexed database that implements a data structure, and
updating, by one or more processors, the indexed database based upon newly predicted activity or activities of interest to the user.

7. The method of claim 6, further comprising:
providing the user with a prompt to accept or reject predicted activities of interest that are proposed for inclusion in the profile of the user.

8. The method of claim 1, wherein the activity or activities of interest to the user comprise one or more of:
attending a gymnasium;
walking;
attending a café or bar or restaurant;
attending the cinema;
walking a dog;
studying a course, or
attending an event or concert.

9. The method of claim 1, wherein the information associated with each user is received as a result of prompting each user to enter details comprising the user's activities of interest, the location of the user, and date and time regarding the user's availability to share an activity of interest with one or more other users.

10. The method of claim 1, wherein verifying the identity of each user comprises:
establishing, by one or more processors, a communication link with one or more processors associated with one or more external databases to obtain information to verify the identity of the user.

11. The method according to claim 10, wherein the one or more external databases comprise any one or more of:
a Passport Office;
a Births, Deaths and Marriages Registry;
a Department of Justice and/or Community Safety Registry; or
a Public Record Office.

12. The method of claim 1, wherein verifying the identity of each user comprises performing one or more of a security and/or a police check.

13. The method of claim 1, wherein data exchanged between the user devices and the one or more processors is encrypted using Security Assertion Markup Language (SAML), wherein a software application operating on each user device employs code obfuscation software to protect downloaded data in a multi-layered Trusted Execution Environment (TEE), with the accuracy of information verified using an encrypted cloud service central administration tool.

14. The method of claim 1, wherein providing the first user with a means of establishing a private and secure communication channel with the matching one or more other users comprises:
providing the first user with a selectable link to establish the private and secure communication channel.

15. The method of claim 14, wherein selection of the link enables a live chat between the first user and the matched other user, wherein communications via the live chat is private and protected using a data masking Host-based Intrusion Detection System (HIDS).

16. The method of claim 1, wherein providing the first user with a means of establishing a private and secure communication channel with the matching one or more other users comprises:
providing, by one or more processors, the first user with a search facility to search for matching one or more other users comprising based on keyword(s) entered by the first user, wherein keyword(s) entered are analysed using one or more artificial intelligence techniques.

17. The method according to claim 16, wherein the search facility further provides the first user with the ability to filter search results, comprising based on one or more of:
an activity or activities of interest of the matching one or more other users,
a location of the matching one or more other users,
a date and time regarding the availability of the one or more other users to share an activity of interest.

18. The method of claim 1, further comprising:
generating, by one or more processors, notifications to matching the one or more other users based on:
the one or more other users being matched and/or selected by the first user for establishing a private and secure communication channel,
the one or more other users being in a geographical location proximal to the first user's location, and
the one or more other users being available to socialise.

19. The computer-implemented system for virtually connecting individuals, the system including one or more processors configured to:
in a user matching step:
receive information associated with each user of a plurality of users, the information sourced from at least one social media account associated with the user and comprising:
an activity or activities of interest to the user,
a location associated with the user, and
a date and time regarding the user's availability to share an activity of interest with one or more other users;
generate a user profile for each user in which the information associated with the user is recorded;
verify, using one or more verification techniques, the identity of each user and updating security details associated with the user profile of the user based upon a verification result; and
compare, using one or more artificial intelligence techniques, the information associated with each verified user to determine a similarity score for each user pair, the similarity score based upon an extent to which the information associated with the users in each user pair is determined as similar;
determine whether the similarity score for each user pair exceeds a pre-defined threshold similarity score thereby indicating a match between verified users;
and in a user communication step that follows the user matching step:
based upon one or more other users determined in the user matching step to be matching with the first user such that the first user and each of the one or more other users forms a matching user pair, provide the first user with a means of establishing a private and secure communication channel with the matching one or more other users; and
receive a request from a first user to establish a private and secure communication channel with one or more of the other users and providing, in response to the request, a communication channel configured to enable the matching users to arrange to participate in one or more of the activities of interest.

20. A non-transitory computer-readable medium comprising computer instruction code that, when executed on a computer, causes one or more processors of the computer to perform the steps of:
in a user matching step:
receiving information associated with each user of a plurality of users, the information sourced from at least one social media account associated with the user and comprising:
an activity or activities of interest to the user;
a location associated with the user; and
a date and time regarding the user's availability to share an activity of interest with one or more other users;
generating a user profile for each user in which the information associated with the user is recorded;
verifying, using one or more verification techniques, the identity of each user and updating security details associated with the user profile of the user based upon a verification result; and
comparing, using one or more artificial intelligence techniques, the information associated with each verified user to determine a similarity score for each user pair, the similarity score based upon an extent to which the information associated with the users in each user pair is determined as similar;
determining whether the similarity score for each user pair exceeds a pre-defined threshold similarity score thereby indicating a match between verified users;
in a user communication step that follows the user matching step:
based upon one or more other determined in the user matching step to be matching with the first user such that the first user and each of the one or more other users forms a matching user pair, providing the first user with a means of establishing a private and secure communication channel with the matching one or more other users; and
receiving a request from a first user to establish a private and secure communication channel with one or more of the other users and providing, in response to the request, a communication channel configured to enable the matching users to arrange to participate in one or more of the activities of interest.

21. (canceled)
